(19) United States
(12) Patent Application Publication
(10) Pub. No.: US 2025/0093748 A1
(43) Pub. Date: Mar. 20, 2025

(54) FOLLOW FOCUS CONTROLLER CIRCUIT, FOLLOW FOCUS CONTROLLER AND PHOTOGRAPHIC SYSTEM

(71) Applicant: Shenzhen Leqi Innovation Co., Ltd., Shenzhen (CN)

(72) Inventors: Wei TANG, Shenzhen (CN); Peiwen HE, Shenzhen (CN); Jinxu LAI, Shenzhen (CN); Zishuai HU, Shenzhen (CN)

(73) Assignee: Shenzhen Leqi Innovation Co., Ltd., Shenzhen, GD (CN)

(21) Appl. No.: 18/961,517

(22) Filed: Nov. 27, 2024

Related U.S. Application Data
(63) Continuation of application No. PCT/CN2023/112822, filed on Aug. 14, 2023.

(30) Foreign Application Priority Data
Sep. 2, 2022 (CN) 202222344522.6

(51) Int. Cl. G03B 13/34

(52) U.S. Cl. CPC G03B 13/34

(57) ABSTRACT

A follow focus controller circuit, a follow focus controller and a photographic system are disclosed. The follow focus controller circuit includes a main circuit and at least one expansion circuit. The main circuit includes a main control unit, a first detection unit, a transmission unit and at least one first connector. The main control unit is electrically connected to the first detection unit, the transmission unit and the first connector. The expansion circuit includes a second detection unit and a second connector, the second detection unit is electrically connected to the second connector, and the second connector is electrically connected to the first connector. The first detection unit and each second detection unit detect angular positions of rotary adjustment members and transmit detection signals to the main control unit. The main control unit processes the detection signals individually and outputs the processed signals through the transmission unit.

### CROSS-REFERENCE TO RELATED APPLICATIONS

The present disclosure is a continuation of International Patent Application No. PCT/CN2023/112822 filed on Aug. 14, 2023, which claims the priority of China Patent Application No. 202222344522.6, filed on Sep. 2, 2022, the entire contents of which are incorporated herein by reference.

### TECHNICAL FIELD

The present disclosure relates to the technical field of photographic devices, and in particular relates to a follow focus controller circuit, a follow focus controller and a photographic system.

### DESCRIPTION OF RELATED ART

During the photographing process, lens focus and focal length of a photographic device need to be adjusted in order to adapt to photography composition, and the photographic device usually also needs to move according to the needs of the picture to be photographed. However, most photographic devices usually have a large weigh, so it can be difficult to manually rotate the lens for zooming during the photographing process. At present, the commonly used solution is to install a lens driver next to the lens to drive a lens focus ring to rotate, and realize the zooming and focusing functions by adjusting a follow focus controller in a wired or wireless connection with the lens driver.

The zoom adjustment and focus adjustment of the lens of the photographic device each need to be driven by a lens driver, and some photographic devices may further need a lens driver to adjust a filter transmittance of the lens. As a result, the photographic device usually needs to be installed with at least two lens drivers, at least two follow focus controllers need to be used to control the respective lens drivers, and an additional follow focus controller is required for each additional lens driver of the photographic device, which may result in a large number of the follow focus controllers, making it inconvenient for a single person to use, and leading to a higher cost.

### SUMMARY

The present disclosure is directed to a follow focus controller circuit, a follow focus controller and a photographic system capable of realizing control of multiple lens drivers by a single follow focus controller, which is more convenient for a single person to use and reduces cost.

In one aspect, a follow focus controller circuit may include a main circuit and at least one expansion circuit. The main circuit includes a main control unit, a first detection unit, a transmission unit and at least one first connector, the main control unit being electrically connected to the first detection unit, the transmission unit and the first connector. The expansion circuit includes a second detection unit and a second connector adapted for connection with the first connector, the second detection unit is electrically connected to the second connector, and the second connector is configured to be electrically connected to the first connector. The first detection unit and each second detection unit are respectively used to detect angular positions of their corresponding rotary adjustment members and transmit detecting signals to the main control unit; the main control unit processes each of the received detecting signals individually and outputs the processed detecting signals via the transmission unit.

In some embodiments, the transmission unit may include a wireless transmission unit, and the main control unit is electrically connected to the wireless transmission unit; and/or, the transmission unit includes a first signal connector, the main control unit being electrically connected to the first signal connector.

In some embodiments, the main circuit further includes a key unit electrically connected to the main control unit; and/or, the main circuit further includes a display unit for displaying state information of the follow focus controller, the display unit being electrically connected to the main control unit; and/or, the main circuit further includes a vibration driving unit electrically connected to the main control unit; and/or, the main circuit further includes an indicator unit being electrically connected to the main control unit.

In some embodiments, the main circuit further includes a power supply management unit and a first power supply unit, the first power supply unit being electrically connected to the power supply management unit to provide a voltage to the power supply management unit, the power supply management unit supplying power to the main control unit, the first detection unit and the transmission unit, the main control unit being electrically connected to the power supply management unit to control on and off states of the power supply of the power supply management unit.

In some embodiments, the expansion circuit further includes a second power supply unit, the second power supply unit being electrically connected to the power supply management unit through the second connector and the first connector in sequence, to supply voltage to the power supply management unit; the second power supply unit is further electrically connected to the second detection unit to supply power to the second detection unit.

In some embodiments, a charge-discharge end of the second power supply unit is electrically connected to a power pin of the second connector, the power pin of the second connector is electrically connected to a power pin of the first connector, the power pin of the first connector is electrically connected to the power supply management unit by means of a unidirectional conductive device, a charge-discharge end of the first power supply unit is electrically connected to the power supply management unit by means of a unidirectional conductive device, and the power pin of the first connector is electrically connected to the charge-discharge end of the first power supply unit.

In some embodiments, the power pin of the second connector is connected to a detection pin of the second connector, a detection pin of the first connector is electrically connected to the detection pin of the second connector, and the main control unit is electrically connected to the detection pin of the first connector for detecting the voltage supplied to the power supply management unit by the expansion circuit; and/or, the power pin of the first connector is electrically connected to the main control unit.

In some embodiments, the expansion circuit further includes a second signal connector, the power pin of the second signal connector is electrically connected to the power pin of the second connector, a transmitting pin and a receiving pin of the second signal connector are respectively electrically connected to a transmitting pin and a receiving pin of the second connector, a transmitting pin and a receiving pin of the first connector are respectively electrically connected to the transmitting pin and the receiving pin of the second connector, and the main control unit is electrically connected to the transmitting pin and receiving pin of the first connector.

In some embodiments, the expansion circuit further includes a charging protocol unit, the power pin of the second signal connector being further electrically connected to the charge-discharge end of the second power supply unit via the charging protocol unit; and/or, the main circuit further includes a charge management unit, the power pin of the first connector being electrically connected to the charge-discharge end of the first power supply unit via the charge management unit.

In some embodiments, the main circuit includes a first switch unit, a conduction end of the first switch unit being electrically connected to a control pin of the first connector, another conduction end of the first switch unit being grounded, and the main control unit being electrically connected to an on/off control end of the first switch unit. The expansion circuit includes a second switch unit, the charge-discharge end of the second power supply unit is electrically connected to a conduction end of the second switch unit, another conduction end of the second switch unit is electrically connected to the power pin of the second connector through a unidirectional conduction device, an on/off control end of the second switch unit is electrically connected to the control pin of the second connector, and the control pin of the second connector is electrically connected with the control pin of the first connector, the another conduction end of the second switch unit is electrically connected to the second detection unit, and the second power supply unit is configured to supply power to the second detection unit through the second switch unit.

In another aspect, a follow focus controller includes a main body, at least one expansion accessory, and the follow focus controller circuit as described above. Each of the main body and the expansion accessory is provided with a rotary adjustment member, the main body and the expansion accessory are detachably connected to each other, the main circuit is provided on the main body, and each expansion circuit is provided on a respective one of the at least one expansion accessory in a one-to-one corresponding manner.

In still another aspect, a photographic system includes at least one follow focus controller as described above.

The technical solution of the follow focus controller circuit of the present disclosure includes a main circuit and at least one expansion circuit. The main circuit includes at least one first connector, each first connector being capable of electrical connection with an expansion circuit, each of the main circuit and the expansion circuit has a detection unit for detecting the angular position of a rotary adjustment member, and the detection signals of the respective detection units are processed by the main control unit of the main circuit and outputted for reception by the corresponding lens driver. As such, the focus controller utilizing the present focus controller circuit can control operations of at least two lens drivers individually, realizing the control of multiple lens drivers by a single focus controller, which is more convenient for a single person to use. In addition, since the signal processing of the detection signal of each expansion circuit is completed by the main control unit of the main circuit, neither of the expansion circuits needs to be provided with the main control unit, which reduces the number of the main control units and thus reduces the cost.

### BRIEF DESCRIPTION OF THE DRAWINGS

FIG. 1 is a block diagram of a follow focus controller circuit according to a first embodiment of the present disclosure;

FIG. 2 is another block diagram of the follow focus controller circuit according to the first embodiment of the present disclosure;

FIG. 3 is a block diagram of a follow focus controller circuit according to a second embodiment of the present disclosure;

FIG. 4 is a block diagram of a follow focus controller circuit according to a third embodiment of the present disclosure;

FIG. 5 is a block diagram of a follow focus controller circuit according to a fourth embodiment of the present disclosure;

FIG. 6 is a block diagram of a follow focus controller circuit according to a fifth embodiment of the present disclosure;

FIG. 7 is a block diagram of a portion of a follow focus controller circuit according to a sixth embodiment of the present disclosure;

FIG. 8 is a block diagram of a portion of a follow focus controller circuit according to a seventh embodiment of the present disclosure;

FIG. 9 is a block diagram of a portion of a follow focus controller circuit according to an eighth embodiment of the present disclosure.

### DESCRIPTION OF THE EMBODIMENTS

The technical solutions of the embodiments of the present disclosure will be described clearly and completely in the following in conjunction with the accompanying drawings, and it is obvious that the described embodiments are only a part of the embodiments and not all of the embodiments of the present disclosure. Based on the embodiments in the present disclosure, all other embodiments obtained by persons of ordinary skill in the art without making creative labor are within the protection scope of the present disclosure.

It is to be noted that all directional indications (such as up, down, left, right, front, back . . . ) in the embodiments of the present disclosure are used only for explaining the relative positional relationship, movement, etc., among the components in a particular orientation (as shown in the accompanying drawings), and the directional indications change accordingly when that particular orientation is changed.

It should also be noted that when an element is described to be “fixed to” or “disposed on” another element, it may be directly disposed on the another element or there may further be an intermediate element between the two elements. When an element is described to be “connected” to another element, it may be directly connected to the another element or there may further be an intermediate element between the two elements.

In addition, the descriptions involving “first”, “second”, etc. in the present disclosure are used for descriptive purposes only and are not to be construed as indicating or implying their relative importance or implicitly specifying the number of the technical features indicated. As a result, a feature defined by terms “first” or “second” may include at least one such feature, either explicitly or implicitly. Furthermore, the technical solutions of the various embodiments may be combined with each other under the condition that such combination is within the capability of persons of ordinary skill in the art, and when the combination of the technical solutions causes conflicts or cannot be realized, it should be considered that the combination of such technical solutions does not exist, and is not within the protection scope of the present disclosure.

The present disclosure proposes a follow focus controller circuit for use in a follow focus controller of a photographic device. The photographic device can be, for example, a camcorder, a camera, and the like, and the follow focus controller is used to control the operation of a lens driver of the photographic device, and the lens driver is used to drive a zoom ring, a focus ring, or a filter adjustment wheel of a lens of the photographic device to perform a zoom adjustment, a focus adjustment, or a transmittance adjustment of the lens.

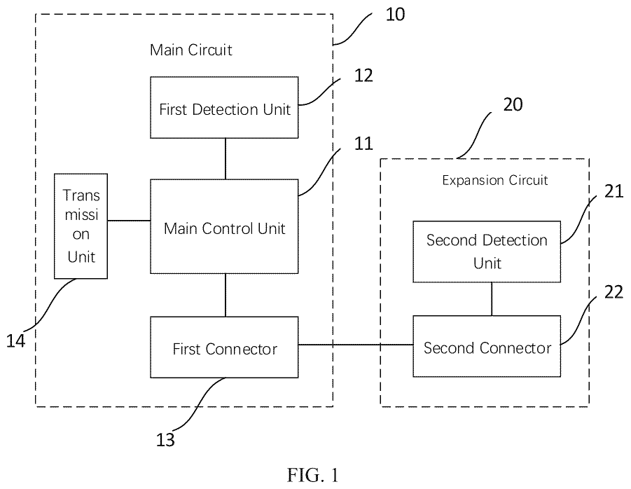

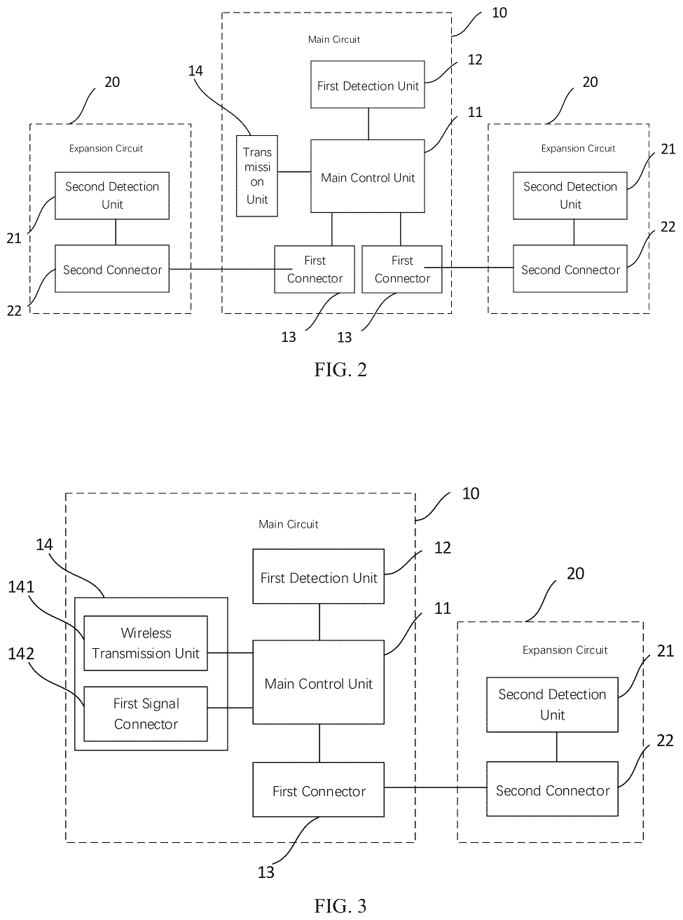

Referring to FIGS. 1 and 2, in this embodiment, the follow focus controller circuit includes a main circuit 10 and at least one expansion circuit 20. The main circuit 10 includes a main control unit 11, a first detection unit 12, a transmission unit 14, and at least one first connector 13. The main control unit 11 is electrically connected to the first detection unit 12, the transmission unit 14, and the first connector 13. The expansion circuit 20 includes a second detection unit 21 and a second connector 22 corresponding to the first connector 13, the second detection unit 21 is electrically connected to the second connector 22, and the second connector 22 is configured to be electrically connected to the first connector 13.

The first detection unit 12 and each second detection unit 21 are respectively used to detect angular positions of their corresponding rotary adjustment member and transmit detection signals to the main control unit 11. The main control unit 11 processes each of the received detection signals and outputs them via the transmission unit 14.

In this embodiment, the number of the first connectors 13 of the main circuit 10 may be determined according to the number of the lens drivers that need to be controlled by the follow focus controller, and each first connector 13 is used to connect one expansion circuit 20. For example, when the follow focus controller needs to control two or three lens drivers individually, the main circuit 10 may include two or three first connectors 13 correspondingly, i.e., the main circuit 10 are correspondingly electrically connected with two or three expansion circuits 20.

In this embodiment, the rotary adjustment member is a structural member provided on the follow focus controller, and the angle of each rotary adjustment member is detected by a corresponding one of the detection units (the first detection unit 12 or the second detection unit 21). The rotary adjustment member may be a knob, a rotary wheel, a rotary shaft, a turntable, or another rotary structural member. In this embodiment, the transmission unit 14 may be a unit that outputs signals in a wireless or wired manner. The signals output by the transmission unit 14 are to be received by the corresponding lens drivers to control the corresponding lens drivers to drive a zoom ring, a focus ring, or a filter adjustment wheel of the lens.

In some embodiments, the first connector 13 and the second connector 22 may be two connectors that are plug-connected for quick connection and quick disconnection. Of course, the first connector 13 and the second connector 22 may also be connected in other manners, such as through magnetic fixing, snap-fit, and the like.

In some embodiments, the first detection unit 12 and/or the second detection unit 21 may be a magnetic angle sensor, or other types of angle sensors or angle detection devices.

The working principle of the follow focus controller circuit of this embodiment is as follows: when the user rotates the rotary adjustment member of the focus controller, the detection unit corresponding to the rotated rotary adjustment member (the first detection unit 12 or the second detection unit 21) outputs a corresponding detection signal according to a current angular position of the rotary adjustment member to the main controlling unit 11. The detection signal of the first detection unit 12 is directly outputted to the main controlling unit 11, while the detection signal of the second detection unit 21 is outputted to the main control unit 11 via the second connector 22 and the first connector 13 sequentially. The main control unit 11, upon receiving the detection signal, performs a preset processing to the detection signal and then outputs the processed signal to the transmission unit 14.

The follow focus controller circuit of this embodiment includes the main circuit 10 and at least one expansion circuit 20. The main circuit 10 has at least one first connector 13, each first connector 13 being electrically connectable to one expansion circuit 20. The main circuit 10 and the expansion circuit 20 each have a detection unit for detecting an angular position of the rotary adjustment member, and the detection signals of the respective detection units are processed by the main control unit 11 of the main circuit 10 and then outputted for reception by the corresponding lens drivers. In this way, the follow focus controller using the present follow focus controller circuit can control the operations of at least two lens drivers individually, realizing the control of multiple lens drivers by a single follow focus controller, which is more convenient for a single person to use. In addition, since the signal processing of the detection signals of each expansion circuit 20 is completed by the main control unit 11 of the main circuit 10, neither of the expansion circuits 20 needs to be provided with a main control unit 11, thereby reducing the number of the main control unit 11 and hence reducing the cost.

In addition, since the electrical connection between the expansion circuit 20 and the main circuit 10 is realized by the connection between the matching first connector 13 and second connector 22, the first connector 13 and the second connector 22 may be of a detachable design. As such, the follow focus controller may be configured to include a main body and at least one expansion accessory that may be detachably mounted (e.g., plug-connection, buckle-connection, snap-fit, etc.) to the main body. For example, the main circuit 10 is disposed on the main body, and each expansion circuit 20 is disposed on one expansion accessory, so that when the user carries the photographic device outdoors, the expansion accessory of the follow focus controller can be detached from the main body so as to be stored separately, thereby facilitating carry and storage; and when it needs to be used, the number of the expansion accessories mounted on the main body can be selected according to the number of the lens drivers that need to be controlled, thereby achieving more flexible and convenient use of the follow focus controller. For example, when two or three lens drivers need to be controlled individually, one or two additional structural modules should be connected; for another example, when only one lens driver needs to be controlled, there is no need to mount the expansion accessory on the main body, and only the main body is needed.

Referring to FIG. 3, in some embodiments, the transmission unit 14 includes a wireless transmission unit 141, and the main control unit 11 is electrically connected to the wireless transmission unit 141. In this embodiment, the main control unit 11 can communicate wirelessly with the lens driver via the wireless transmission unit 141 to realize wireless remote control of the lens driver.

In some embodiments, the wireless transmission unit 141 may be implemented as a ZIGBEE communication module, for example, the wireless transmission unit 141 includes a 2.4G wireless transmission unit 141, an RF amplifier, and an antenna that are sequentially electrically connected. Of course, in other embodiments, the wireless transmission unit 141 may also be another wireless communication module.

Referring to FIG. 3, in some embodiments, the transmission unit 14 includes a first signal connector 142, and the main control unit 11 is electrically connected to the first signal connector 142. In this embodiment, the main control unit 11 may be electrically connected to the lens driver through the first signal connector 142 with a signal line to realize wired control of the lens driver. The first signal connector 142 may be of a type-C interface or another type of signal interface.

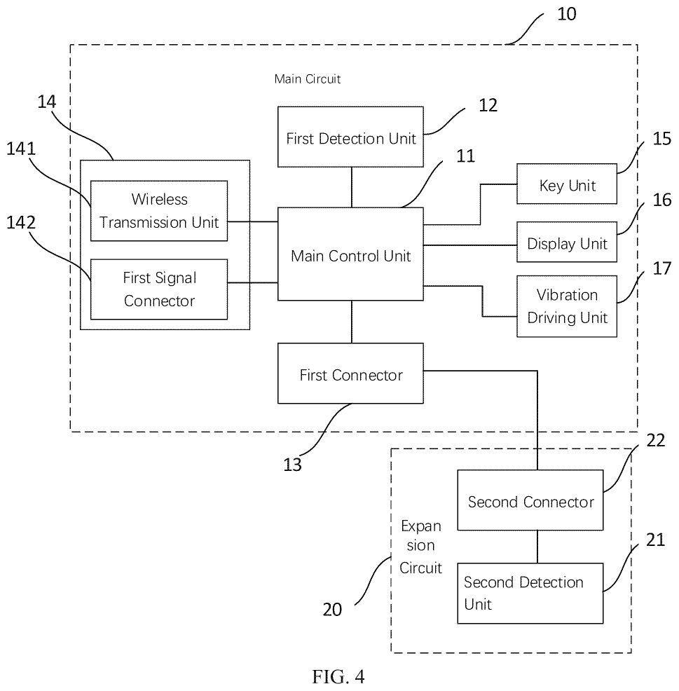

Referring to FIG. 4, in some embodiments, the main circuit 10 further includes a key unit 15 electrically connected to the main control unit 11. In this embodiment, the key unit 15 may include a plurality of function keys, and each function key is configured to generate a different electrical signal to be sent to the main control unit 11, so that the user can realize various operations such as controlling, setting, and adjustment of the follow focus controller through the key unit 15.

In some embodiments, the main circuit 10 further includes a display unit 16 (e.g., an OLED display) for displaying status information of the follow focus controller, and the display unit 16 is electrically connected to the main control unit 11. By displaying various status information of the follow focus controller through the display, the user can be more intuitively informed of the current state of the follow focus controller. The various status information of the follow focus controller may include power information, angular position data of each rotary adjustment member, the state of the connected lens driver, and so on. The display unit 16 may also, responsive to operation of the key unit 15, display corresponding interfaces (e.g., a menu interface, a setup interface, and so on) to enable more convenient user operation.

In some embodiments, the main circuit 10 further includes a vibration driving unit 17 electrically connected to the main control unit 11. The main control unit 11 may control the vibration driving unit 17 to vibrate under some preset circumstances to remind the user. For example, upon detecting that the power level is lower than a power threshold, an error occurs in the settings, or rotation of the lens driver is blocked, the main control unit 11 may control the vibration driving unit 17 to vibrate to remind the user.

In some embodiments, the main circuit 10 further includes an indicator unit electrically connected to the main control unit 11. In this embodiment, the main control unit 11 may control a display state (e.g., display color, display mode, display brightness, etc.) of the indicator unit to provide light indication according to the state of the follow focus controller. The indicator unit may be used to display the power state, the working state, the charging state, etc. of the follow focus controller.

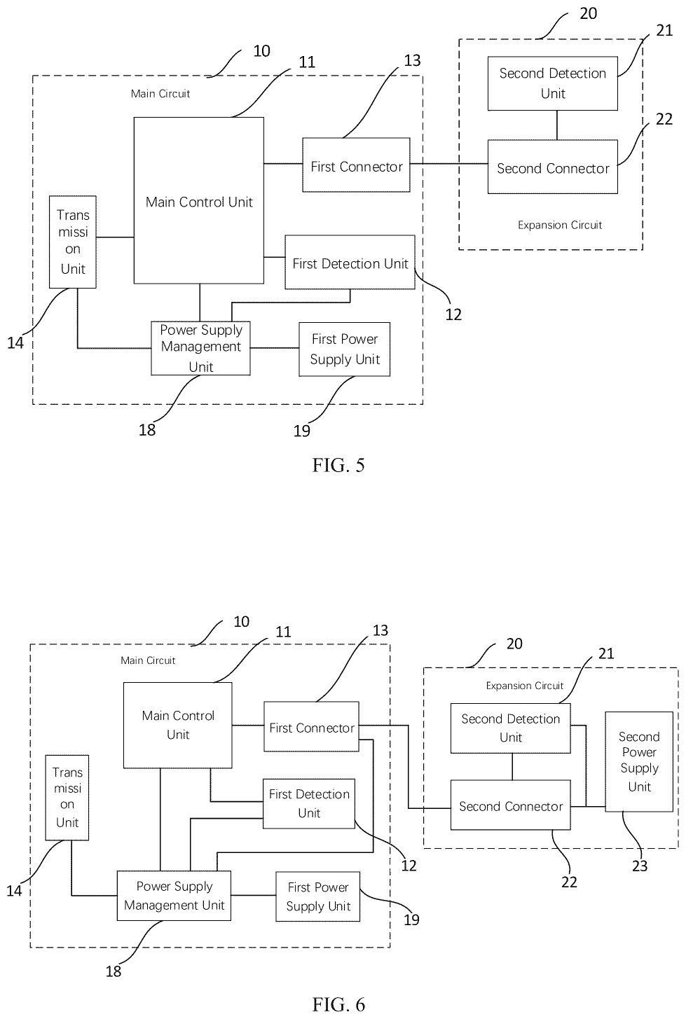

Referring to FIG. 5, in this embodiment, the main circuit 10 further includes a power supply management unit 18 and a first power supply unit 19 electrically connected to the power supply management unit 18. The first power supply unit 19 provides a voltage to the power supply management unit 18, and the power supply management unit 18 supplies power to the main control unit 11, the first detection unit 12 and the transmission unit 14. The main control unit 11 is electrically connected to the power supply management unit 18 to control on/off states of the power supply to the power supply management unit 18. The first power supply unit 19 may be a power storage device, such as a storage battery.

In this embodiment, the main control unit 11, the first detection unit 12 and the transmission unit 14 of the main circuit 10 may be powered by the first power supply unit 19 through the power supply management unit 18. That is, the power supply management unit 18 receives the voltage provided by the first power supply unit 19 and outputs the voltage to the main control unit 11, the first detection unit 12 and the transmission unit 14 for operation. The main control unit 11 controls the on/off states of the power supply management unit 18 (i.e., controls whether the power supply management unit 18 outputs a voltage or not) by means of turn-on and turn-off signals, i.e., controls the main circuit 10 of the follow focus controller circuit to turn on or off. The turn-on and turn-off signals may be generated by the main control unit 11 according to key signals of the key unit 15, or they may be generated by the main control unit 11 based on a specific state of the follow focus controller (e.g., a low battery level state, an abnormal working state, etc.).

Of course, in some embodiments, the first power supply unit 19 may also provide a voltage to the expansion circuit 20 through the first connector 13 to power the expansion circuit 20.

Referring to FIG. 6, in this embodiment, the expansion circuit 20 further includes a second power supply unit 23, which is electrically connected to the power supply management unit 18 through the second connector 22 and the first connector 13 in sequence to provide a voltage to the power supply management unit 18. The second power supply unit 23 is also electrically connected to the second detection unit 21 to provide power to the second detection unit 21. The second power supply unit 23 may be a power storage device, such as a storage battery.

In this embodiment, the expansion circuit 20 has its own power supply to supply power to its own second detection unit 21, and also provides voltage to the power supply management unit 18 through the first connector 13 for the power supply management unit 18 to supply power to various power-consuming parts of the main circuit 10. The main power-consuming part of the follow focus controller is the main circuit 10, and the power consumption of the expansion circuit 20 itself is small. In the present embodiment, the second power supply unit 23 of the expansion circuit 20 also provides voltage to the main circuit 10, so that even when the power of the first power supply unit 19 is low or is exhausted, the power supplied by the second power supply unit 23 still allows the main circuit 10 to continue to work, thereby effectively enhancing the endurance of the follow focus controller.

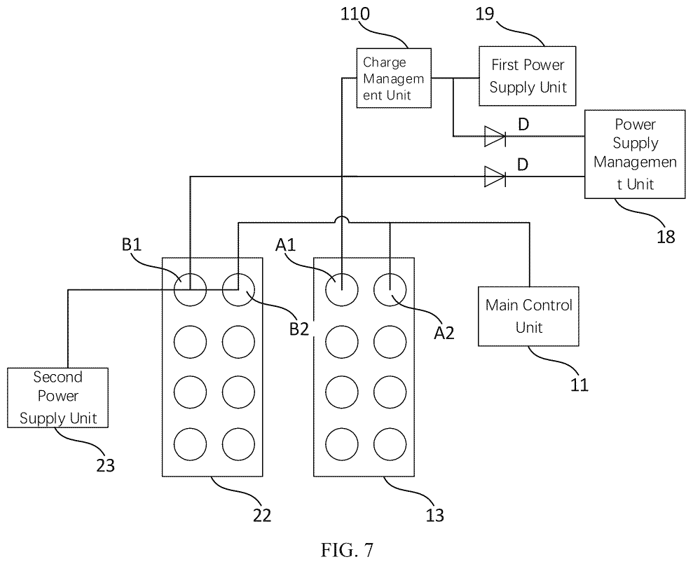

Referring to FIG. 7, in this embodiment, a charge-discharge end of the second power supply unit 23 is electrically connected to a power pin B1 of the second connector 22, the power pin B1 of the second connector 22 is electrically connected to a power pin A1 of the first connector 13, the power pin A1 of the first connector 13 is electrically connected to the power supply management unit 18 through a unidirectional conduction device D, and a charge-discharge end of the first power supply unit 19 is electrically connected to the power supply management unit 18 through a unidirectional conduction device D, and the power pin A1 of the first connector 13 is electrically connected to the charge-discharge end of the first power supply unit 19.

In this embodiment, each of the first power supply unit 19 and the second power supply unit 23 is electrically connected to the power supply management unit 18 via a unidirectional conduction device D (e.g., a diode) and, therefore, the voltages output from the first power supply unit 19 and the second power supply unit 23 do not affect each other. In addition, the power pin A1 of the first connector 13 is electrically connected to the charge-discharge end of the first power supply unit 1. As such, when the power of the first power supply unit 19 is low, the voltage output from the charge-discharge end of the second power supply unit 23 can further be used to charge the first power supply unit 19, which gives priority to ensuring that the first power supply unit 19 has sufficient power to thereby ensure endurance of the main circuit 10.

In some embodiments, the main circuit 10 further includes a charge management unit 110, and the power pin A1 of the first connector 13 is electrically connected to the charge-discharge end of the first power supply unit 19 via the charge management unit 110. The charge management unit 110 is used to control the charging of the first power supply unit 19, for example, controlling the charging mode, regulating the charging voltage, and the like.

Referring to FIG. 7, in some embodiments, a power pin B1 of the second connector 22 is connected to a detecting pin B2 of the second connector 22, a detecting pin A2 of the first connector 13 is electrically connected to the power pin B2 of the second connector 22, and the main control unit 11 is electrically connected to the power pin A2 of the first connector 13 for detecting the voltage supplied by the expansion circuit 20 to the power supply management unit 18.

In this embodiment, the main control unit 11 may determine whether the first connector 13 is connected to an expansion circuit 20 (i.e., determine whether there is an expansion accessory connected to the first connector 13) based on a voltage signal of the detecting pin A2 of the first connector 13, so as to perform a corresponding operation (e.g., switching the working mode, switching the display mode, etc.). Of course, the main control unit 11 may also determine the level of the input voltage based on the voltage signal of the detecting pin A2 of the first connector 13.

In some embodiments, the power pin A1 of the first connector 13 is electrically connected to the main control unit 11. As such, when the first connector 13 is connected to an expansion circuit 20, even when the main circuit 10 is in a dormant or shutdown state, the second power supply unit 23 can directly supply power to the main control unit 11 through the power pin A1 of the first connector 13, thereby enabling the main control unit 11 to wake up the main circuit 10 or turn on the main circuit 10. That is, when the main body is in a dormant or shutdown state, upon connection of an expansion accessory, the main body can be woken up or made to power on.

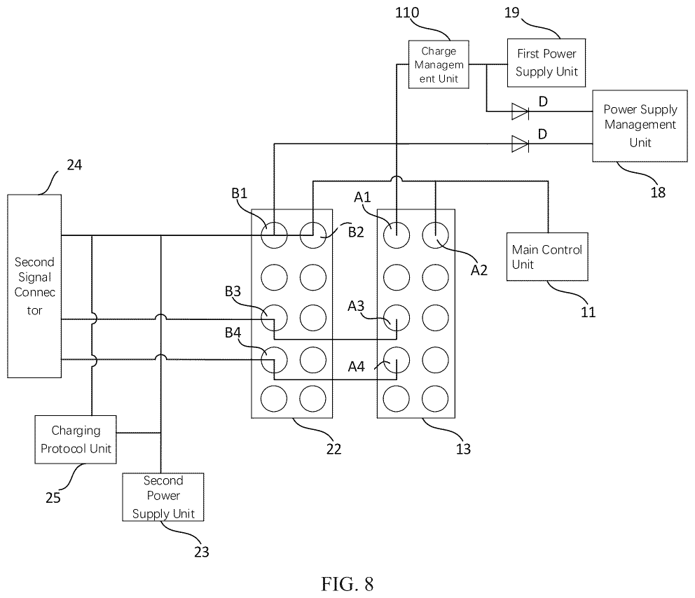

Referring to FIG. 8, in this embodiment, the expansion circuit 20 further includes a second signal connector 24. A power pin of the second signal connector 24 is electrically connected to the power pin B1 of the second connector 22. A transmitting pin (not labeled) and a receiving pin (not labeled) of the second signal connector 24 are electrically connected to a transmitting pin B3 and a receiving pin B4 of the second connector 22, respectively. A transmitting pin A3 and a receiving pin A4 of the first connector 13 are electrically connected to the transmitting pin B3 and the receiving pin B4 of the second connector 22. The main control unit 11 is electrically connected to the transmitting pin A3 and the receiving pin A4 of the first connector 13. The second signal connector 24 may be of a type-C interface or another type of signal interface.

In this embodiment, when the second signal connector 24 is connected to power, the power pin of the second signal connector 24 outputs a voltage to the power pin B1 of the second connector 22, which in turn supplies power to the main circuit 10. When the second signal connector 24 is connected to a lens driver via a signal line, the main control unit 11 may process the detection signals fed back from the detection unit and output the processed signals through the second signal connector 24, or it may receive signals fed back from the lens driver through the second signal connector 24. That is, the detection signals processed by the main control unit 11 are transmitted sequentially through the transmitting pin A3 of the first connector 13, the transmitting pin B3 of the second connector 22, and then are outputted through the transmitting pin of the second signal connector 24; the signals fed back from the lens driver are transmitted sequentially through a receiving pin of the first signal connector 142 and the receiving pin B4 of the second connector 22, and then through the receiving pin A4 of the first connector 13 to the main control unit 11.

In some embodiments, the expansion circuit 20 further includes a charging protocol unit 25, and the power pin of the second signal connector 24 is also electrically connected to the charge-discharge end of the second power supply unit 23 via the charging protocol unit 25. As such, when the second signal connector 24 is connected to a power source, the output voltage of the power pin of the second signal connector 24 may be used to charge the second power supply unit 23. The charging protocol unit 25 may include a fast-charging protocol such that the output voltage of the power pin of the second signal connector 24 may be used to fast charge the second power supply unit 23.

In some embodiments, the charging protocol unit 25 may be electrically connected to an indicator light group, and the indicator light group may be used to display the current power level and charging status of the second power supply unit 23, for example, the indicator light group displays red color indicating a 20% power level, a first light of the indicator light group displays green color indicating a 60% power level, a second light of the indicator light group displays green color indicating a 100% power level, a red light of the indicator light group lights up indicating a normal charging mode, the indicator light group displays blue color indicating a fast-charging mode, and the indicator light group keeps lighting indicating a full charge status. In addition, the charging protocol unit 25 may be electrically connected to a key, and the charging protocol unit 25 may switch the power consumption mode of the expansion circuit 20 by pressing the key. For example, the expansion circuit 20 enters a low power consumption mode when the key is pressed down, and switches back to a normal power consumption mode when the key is popped up to its original state.

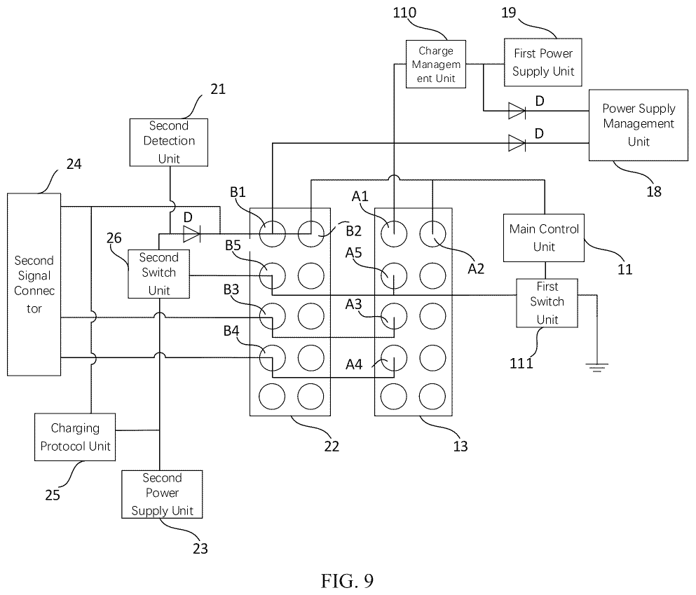

Referring to FIG. 9, in this embodiment, the main circuit 10 includes a first switch unit 111, a conduction end of the first switch unit 111 is electrically connected to a control pin A5 of the first connector 13, another conduction end of the first switch unit 111 is grounded, and the main control unit 11 is electrically connected to an on/off control end of the first switch unit 111.

The expansion circuit 20 includes a second switch unit 26, the charge-discharge end of the second power supply unit 23 is electrically connected to a conduction end of the second switch unit 26, another conduction end of the second switch unit 26 is electrically connected to the power pin B1 of the second connector 22 via a unidirectional conduction device D, and an on/off control end of the second switch unit 26 is electrically connected to a control pin B5 of the second connector 22, and the control pin B5 of the second connector 22 is connected to the control pin A5 of the first connector 13. The another conduction end of the second switch unit 26 is electrically connected to the second detection unit 21, and the second power supply unit 23 supplies power to the second detection unit 21 through the second switch unit 26. The unidirectional conduction device D between the another conduction end of the second switch unit 26 and the power pin B1 of the second connector 22 is used to prevent the voltage output from the power pin of the second signal connector 24 from being directly supplied to the second detection unit 21 which would result in the main control unit 11 being unable to control turn-on/turn-off of the power supply of the second detection unit 21.

In this embodiment, the main control unit 11 controls the on/off state of the second switch unit 26 by controlling the on/off state of the first switch unit 111, thereby controlling the on/off state of the output of the second power supply unit 23. The main control unit 11 works specifically as follows: the main control unit 11 controls the first switch unit 111 to turn on or off by supplying different level signals to the on/off control end of the first switch unit 111; when the first switch unit 111 is turned on, the control pin A5 of the first connector 13 is pulled down to ground, then the control pin B5 of the second connector 22 and the on-off control end the second switch unit 26 are both grounded, the second switch unit 26 is turned on, and the second power supply unit 23 outputs normally; when the first switch unit 111 is turned off, the control pin A5 of the first connector 13 is not grounded, then the control pin B5 of the second connector 22 and the on-off control end of the second switch unit 26 are both not grounded, the second switch unit 26 is turned off, and the output of the second power supply unit 23 is disconnected.

The present disclosure further provides a follow focus controller including a main body, at least one expansion accessory, and the above-mentioned follow focus controller circuit. The specific construction of the follow focus controller circuit may be understood by referring to the above embodiments. Because the present follow focus controller adopts all the technical solutions of all the above embodiments of the follow focus controller circuit, it has at least all the beneficial effects of the technical solutions of the above embodiments, which will not be elaborated herein.

Each of the main body and the expansion accessory is provided with a rotary adjustment member, the main body and the expansion accessory are detachably connected to each other, the main circuit is disposed on the main body, and the at least one expansion circuit is disposed on a respective one of the at least one expansion accessory in a one-to-one correspondence manner. The rotary adjustment member may be a knob, a rotary wheel, a rotary shaft, a turntable, or another rotary structural member.

The present disclosure further provides a photographic system including at least one of the above-mentioned follow focus controllers, and the specific construction of the focus controllers may be understood by referring to the above-described embodiments. Because the present photographic system adopts all the technical solutions of all the above-described focus controllers, it has at least all the beneficial effects of the technical solutions of the above-described embodiments, which will not be elaborated herein.

The above mentioned are only a part of or preferred embodiments of the present invention, and neither the text nor the accompanying drawings can limit the scope of the protection scope of the present invention. Under the concept of the present invention, all equivalent structural transformations made on the basis of the embodiments and accompanying drawings of the present disclosure, or their direct or indirect applications in other related technical fields are included in the protection scope of the present invention.

What is claimed is:

1. A follow focus controller circuit, comprising a main circuit and at least one expansion circuit;
wherein the main circuit includes a main control unit, a first detection unit, a transmission unit and at least one first connector, the main control unit being electrically connected to the first detection unit, the transmission unit and the first connector;
wherein the expansion circuit includes a second detection unit and a second connector adapted for connection with the first connector, the second detection unit is electrically connected to the second connector, and the second connector is configured to be electrically connected to the first connector;
wherein the first detection unit and each second detection unit are respectively configured to detect angular positions of their corresponding rotary adjustment members and transmit detecting signals to the main control unit; the main control unit is configured to process each of the received detecting signals individually and output the processed detecting signals via the transmission unit.

2. The follow focus controller circuit according to claim 1, wherein the transmission unit includes a wireless transmission unit, the main control unit being electrically connected to the wireless transmission unit.

3. The follow focus controller circuit according to claim 1, wherein the transmission unit includes a first signal connector, the main control unit being electrically connected to the first signal connector.

4. The follow focus controller circuit according to claim 1, wherein the main circuit further includes a key unit electrically connected to the main control unit.

5. The follow focus controller circuit according to claim 1, wherein the main circuit further includes a display unit for displaying state information of the follow focus controller, the display unit being electrically connected to the main control unit.

6. The follow focus controller circuit according to claim 1, wherein the main circuit further includes a vibration driving unit electrically connected to the main control unit.

7. The follow focus controller circuit according to claim 1, wherein the main circuit further includes an indicator unit being electrically connected to the main control unit.

8. The follow focus controller circuit according to claim 1, wherein the main circuit further includes a power supply management unit and a first power supply unit, the first power supply unit being electrically connected to the power supply management unit to provide a voltage to the power supply management unit, the power supply management unit supplying power to the main control unit, the first detection unit and the transmission unit, the main control unit being electrically connected to the power supply management unit to control on and off states of the power supply of the power supply management unit.

9. The follow focus controller circuit according to claim 8, wherein the expansion circuit further includes a second power supply unit, the second power supply unit being electrically connected to the power supply management unit through the second connector and the first connector in sequence, to supply voltage to the power supply management unit; the second power supply unit being further electrically connected to the second detection unit to supply power to the second detection unit.

10. The follow focus controller circuit according to claim 9, wherein a charge-discharge end of the second power supply unit is electrically connected to a power pin of the second connector, the power pin of the second connector is electrically connected to a power pin of the first connector, the power pin of the first connector is electrically connected to the power supply management unit by means of a unidirectional conductive device, a charge-discharge end of the first power supply unit is electrically connected to the power supply management unit by means of a unidirectional conductive device, and the power pin of the first connector is electrically connected to the charge-discharge end of the first power supply unit.

11. The follow focus controller circuit according to claim 10, wherein the power pin of the second connector is connected to a detection pin of the second connector, a detection pin of the first connector is electrically connected to the detection pin of the second connector, and the main control unit is electrically connected to the detection pin of the first connector for detecting the voltage supplied to the power supply management unit by the expansion circuit.

12. The follow focus controller circuit according to claim 10, wherein the power pin of the first connector is electrically connected to the main control unit.

13. The follow focus controller circuit according to claim 10, wherein the expansion circuit further includes a second signal connector, a power pin of the second signal connector is electrically connected to the power pin of the second connector, a transmitting pin and a receiving pin of the second signal connector are respectively electrically connected to a transmitting pin and a receiving pin of the second connector, a transmitting pin and a receiving pin of the first connector are respectively electrically connected to the transmitting pin and the receiving pin of the second connector, and the main control unit is electrically connected to the transmitting pin and receiving pin of the first connector.

14. The follow focus controller circuit according to claim 13, wherein the expansion circuit further includes a charging protocol unit, the power pin of the second signal connector being further electrically connected to the charge-discharge end of the second power supply unit via the charging protocol unit.

15. The follow focus controller circuit according to claim 13, wherein the main circuit further includes a charge management unit, the power pin of the first connector being electrically connected to the charge-discharge end of the first power supply unit via the charge management unit.

16. The follow focus controller circuit according to claim 13, wherein the main circuit includes a first switch unit, a conduction end of the first switch unit being electrically connected to a control pin of the first connector, another conduction end of the first switch unit being grounded, and the main control unit being electrically connected to an on/off control end of the first switch unit;
the expansion circuit includes a second switch unit, the charge-discharge end of the second power supply unit is electrically connected to a conduction end of the second switch unit, another conduction end of the second switch unit is electrically connected to the power pin of the second connector through a unidirectional conduction device, an on/off control end of the second switch unit is electrically connected to the control pin of the second connector, and the control pin of the second connector is electrically connected with the control pin of the first connector, the another conduction end of the second switch unit is electrically connected to the second detection unit, and the second power supply unit is configured to supply power to the second detection unit through the second switch unit.

17. A follow focus controller, comprising a main body, at least one expansion accessory, and a follow focus controller circuit according to claim 1, wherein each of the main body and the at least one expansion accessory is provided with a rotary adjustment member, the main body and each of the at least one expansion accessory are detachably connected to each other, the main circuit is disposed on the main body, and each of the at least one expansion circuit is disposed on a respective one of the at least one expansion accessory in a one-to-one correspondence manner.

18. A photographic system, comprising at least one follow focus controller according to claim 17.
